(19) United States
(12) Patent Application Publication
(10) Pub. No.: US 2006/0285142 A1
(43) Pub. Date: Dec. 21, 2006

(54) Print option setting method and print option setting device

(75) Inventor: Yong-jun Cho, Suwon-si (KR)

Correspondence Address: STEIN, MCEWEN & BUI, LLP, 1400 EYE STREET, NW, SUITE 300, WASHINGTON, DC, 20005, US

(73) Assignee: Samsung Electronics Co., Ltd., Suwon-si (KR)

(21) Appl. No.: 11/446,257

(22) Filed: Jun. 5, 2006

(30) Foreign Application Priority Data
Jun. 17, 2005 (KR) 2005-52652

(51) Int. Cl. G06F 3/12

(52) U.S. Cl. 358/1.13; 358/1.15

(57) ABSTRACT

A print option setting method for a print option setting device to set print options for a document, comprising requesting a printout of the document, determining whether first setting information as print options that are set when the document was previously printed exists, and printing the document based on the first setting information if the first setting information exists.

### CROSS-REFERENCE TO RELATED APPLICATION

This application claims the benefit under 35 U.S.C. § 119 of Korean Patent Application No. 2005-52652, filed on Jun. 17, 2005, in the Korean Intellectual Property Office, the disclosure of which is incorporated herein by reference.

### BACKGROUND OF THE INVENTION

1. Field of the Invention

An aspect of the present invention relates to print option setting method and print option setting device, and, more particularly to print option setting method and print option setting device to automatically set current print options to previous options used for printout of a document without requiring additional preparation by a user.

2. Description of the Related Art

In general, printer drivers convert a document for a printout of the document, the document being created in a certain application program, into data that image-forming devices recognize, and offer a print option window as a user interface (UI) window enabling a user to set print options for a printout document such as the number of copies, paper size, resolution, and so on.

In order to print a document for printout, a user changes initial values of print options using a print option window offered by a printer driver. The printer driver creates printout data corresponding to differences between the values of the changed print options and their initial values, and sends the created printout data to an image-forming device. Thus, the image-forming device prints the document based on the print options changed by the user.

Meanwhile, if a user wants to print the same document once more, the printer driver displays the print option window having the initial values for the print options. As such, if the user wants to print the document again based on the previously changed print options, the user has to set the options again to the previous print options. That is, in the related art, when a user wants to print the same document again based on the previous print options, the user has to receive a print option window and manually set options according to the previous print options one by one every time he or she wants to print the same document.

Thus, the user is required to change and re-set print options on a print option window every time the user prints the same document using a conventional printer driver, since he or she can not print the same document based on the previous print options by simply inputting a print command offered by general application programs.

### SUMMARY OF THE INVENTION

Aspects of the present invention have been developed in order to solve the above and/or other drawbacks and problems associated with the conventional arrangement. Another aspect of the present invention provides a print option setting method and device capable of solving a problem that a user cannot obtain printouts based on previously used print options without his or her extra jobs.

The foregoing and/or other aspects and advantages are substantially realized by providing a print option setting method for a print option setting device to set print options for a document, comprising requesting a printout of the document, determining whether first setting information as print options that are set when the document was previously printed exists, and printing the document based on the first setting information if the first setting information exists.

The foregoing and/or other aspects and advantages are substantially realized by providing a print option setting device to set print options for a document via a display unit, comprising a setting information storage unit to store first setting information as print options set to the document when the document is printed, a setting information decision unit to determine whether the first setting information exists in the setting information storage unit if the document is requested for printout, and a control unit to input the first setting information from the setting information storage unit if the first setting information exists, to generate a print option check window querying whether the document is printed based on the first setting information, and to activate the display unit to display the print option check window.

Additional and/or other aspects and advantages of the invention will be set forth in part in the description which follows and, in part, will be obvious from the description, or may be learned by practice of the invention.

### BRIEF DESCRIPTION OF THE DRAWINGS

These and/or other aspects and advantages of the invention will become apparent and more readily appreciated from the following description of the embodiments, taken in conjunction with the accompanying drawings of which:

FIG. 1 is a block diagram for schematically showing a printout data output device to which a print option setting device is applied according to an embodiment of the present invention;

FIG. 2 is a block diagram for showing in detail a print option setting unit shown in FIG. 1;

FIGS. 3A to 3E are views for exemplarily showing a print window displayed on a display unit by a printer driver unit of FIG. 1;

FIG. 4 is a flow chart for schematically explaining a method of printing a document based on the print option setting method of FIG. 1; and

FIG. 5 is a block diagram for showing an image-forming device to which the print option setting device is applied according to another embodiment of the present invention.

### DETAILED DESCRIPTION OF THE EMBODIMENTS

Reference will now be made in detail to the present embodiments of the present invention, examples of which are illustrated in the accompanying drawings, wherein like reference numerals refer to the like elements throughout. The embodiments are described below in order to explain the present invention by referring to the figures.

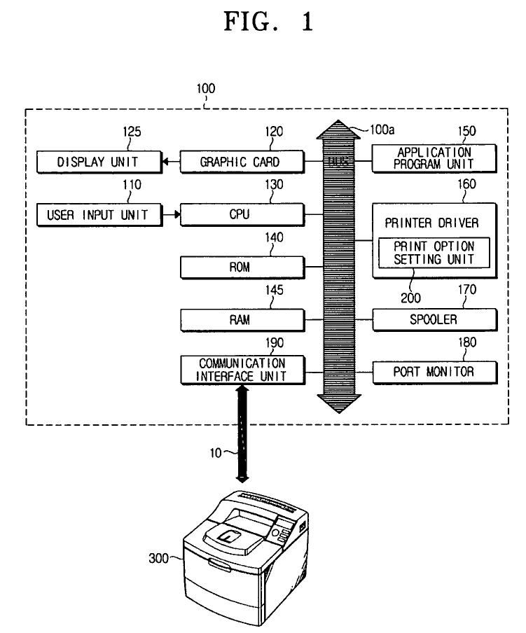

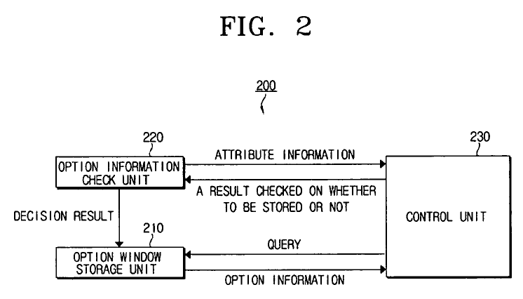

FIG. 1 is a block diagram for schematically showing a printout data output device to which a print option setting device is applied according to an embodiment of the present invention, and FIG. 2 is a block diagram for showing in detail the print option setting unit shown in FIG. 1. As show in FIG. 1, a printout data output device 100 employing a print option setting device is a device that creates and sends printout data to an image-forming device 300. The image-forming device 300 is a device having a print function. A communication network 10 may be built with cable connected to a parallel port or a Universal Serial Bus (USB) port, or may be built in a Local Area Network (LAN) or through some other type of wireless network.

The printout data output device 100 may be a host computer, which is installed with a printer driver related to the image-forming device 300. The image-forming device 300 may be a printer.

The printout data output device 100 comprises a user input unit 110, a graphic card 120, a display unit 125, a central processing unit (CPU) 130, a ROM 140, a RAM 145, an application program unit 150, a printer driver 160, a spooler 170, a port monitor 180, and a communication interface unit 190. The bus 100a is a data transfer path among the respective components stated above.

The user input unit 110 is a user interface that allows a user to request a function supported by the printout data output device 100, which may comprise a keyboard, mouse, touch panel, or the like. The user input unit 110 outputs a printout request signal requesting printout for a certain document to the CPU 130. The graphic card 120 processes a general video signal into a displayable signal, and outputs the displayable signal to the display unit 125. In particular, the graphic card 120 signal-processes and displays a print option window offered by the printer driver 160 to the display unit 125. The display unit 125 is a monitor implemented by a Cathode Ray Tube (CRT), a Liquid Crystal Display (LCD), or the like, and displays the print option window offered by the graphic card 120. The CPU 130 controls overall operations of the printout data output device 100 using various control programs stored in advance. The CPU 130 runs an application program and a printer driver that are related to printout operations, if a printout request signal is inputted from the user input unit 110. The ROM 140 is a non-volatile memory unit, which stores various control programs necessary to implement functions of the printout data output device 100. The RAM 145 is a volatile memory unit, into which programs to be launched by the CPU 130 are loaded and stored or into which data or the like, which are processed by the CPU 130, are stored.

The application program unit 150 is provided with application programs enabling a user to create diverse documents. In order to print a document created in the application program unit 150, the application program unit 150 sends the document and the attribute information thereof to the printer driver. The attribute information of the document may contain the date on which the document is finally edited or stored, a document file name, a document file size, and/or a document storage location. The application programs may comprise a word processor, a database program, a web browser, a development tool, Paint Brush, an image-editing program, and so on.

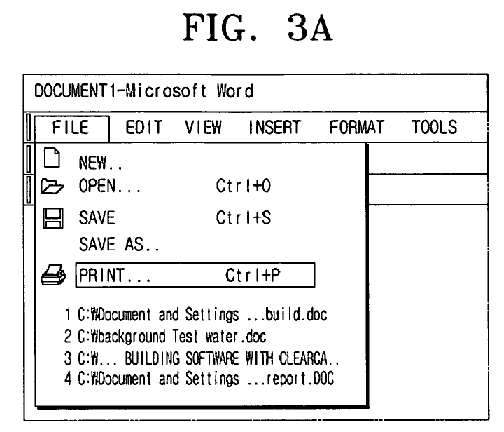

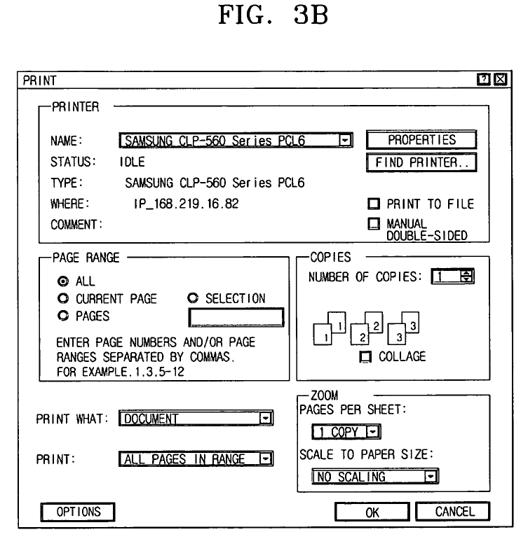

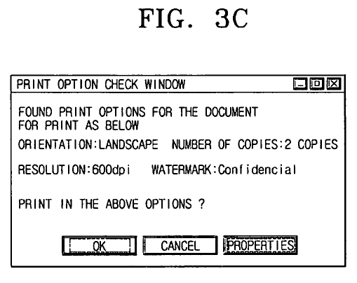

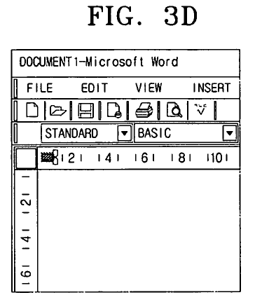

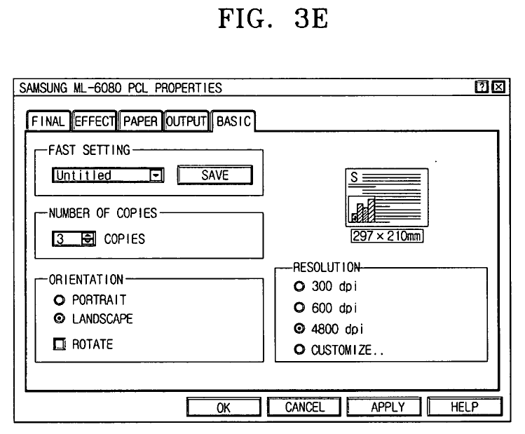

The printer driver 160 converts the document, the attribute information of the document, and the print option information into printout data. Further, the printer driver 160 provides a print option window enabling a user to set document printout options, as shown in FIG. 3E.

The printout data has a data format that the image-forming device 300 recognizes. Further, the print options may include a paper size, the number of pages in a printed sheet of paper, a print range, a print orientation, the number of copies, and/or print quality. Each print option has a default value set when the printer driver is installed.

For example, the default values set to the print options may be ‘vertical’ for a default value for paper orientation and ‘1’ for a default value for the number of copies. Such default values set to each print option may be changed by user manipulation of the user input unit 110.

The printer driver 160 has a printout option setting unit 200 to allow for a setting of document printout options. As shown n FIG. 2, the print option setting unit 200 comprises a setting information storage unit 210, a setting information decision unit 220, and a control unit 230.

When a certain document is printed, default values for print options are changed to new first option information, and, if the certain document is printed based on the changed first option information, the setting information storage unit 210 stores the first option information. That is, the first option information is information about print options set when the certain document is most recently printed.

The setting information storage unit 210 stores the first option information corresponding to attribute information of the printed document. For example, if a document is printed with the number of copies being changed from ‘1’ to ‘2’ and the print orientation is changed from ‘portrait’ to ‘vertical’, the setting information storage unit 210 stores the first option information having the number of copies changed to ‘2’ and the print orientation changed to ‘vertical’. Here, it is possible to store unchanged default values together with the number of copies and the print orientation that have been changed.

Further, if the setting information storage unit 210 inputs the attribute information for a document requested for printout from the setting information decision unit 220, the setting information storage unit 210 checks whether to store the first option information corresponding to the inputted attribute information. The setting information storage unit 210 then outputs a result of the check to the setting information decision unit 220.

Meanwhile, if a user selects the File menu of an application program over a document created in the application program unit 150 through the user input unit 110 and selects a print order out of the options displayed upon the selection of the File menu, as shown in FIG. 3A, the application program unit 150 sends the document and the attribute information for the document to the printer driver 160 and displays a print window on the display unit 125 as shown in FIG. 3B. If the user then selects the OK or Enter button on the print window, the user input unit 110 outputs the printout request signal for a request for printout for the corresponding document to the CPU 130. Accordingly, the CPU 130 applies the printout request signal to the printer driver 160 to create printout data.

If a printout request for a certain document is received, the setting information decision unit 220 determines if the document has been printed before based on print options having different values from default values. That is, the setting information decision unit 220 outputs to the setting information storage unit 210 the attribute information about the document outputted from the application program unit 150. The setting information storage unit 210 checks whether the first option information corresponding to the attribute information of the inputted document is stored, and outputs a result of the check to the setting information decision unit 220. Depending on the result of the check, the setting information decision unit 220 checks whether the document has been printed before based on the first option information, and outputs a result of the check to the control unit 230.

Depending on a decision result of the setting information decision unit 220 about whether the document has been printed before, the control unit 230 queries the setting information storage unit 210 for the first option information if the document has been printed before, generates a print option check window, and displays a pop-up window on the display unit 125, for example.

That is, if the setting information decision unit 220 decides that the document has been printed before, the control unit 230 sends the setting information storage unit 210 a query on whether the first option information is stored. The setting information storage unit 210 searches for the first option information corresponding to the query and outputs the first option information to the control unit 230. Thus, the control unit 230 generates the print option check window and displays the first option information on the display unit 125, as shown in FIG. 3C, in order to enable a user to select whether to print the document according to the first option information.

Further, if the option, ‘Yes,’ is selected through the user input unit 110, the printer driver 160 converts the document, the document attribute information, and the first option information into printout data. That is, the document is printed in two copies each in horizontal orientation, having 600 dpi resolution, based on the first option information as shown in FIG. 3C. Further, the print option check window indicates that the document was printed before based on the print option shown in FIG. 3C.

Meanwhile, a user may also input a print order over a document created in the application program unit 150 by selecting a short-cut icon for a print command input displayed on the menu bar of an application program as shown in FIG. 3D.

Here, as the user input unit 110 outputs a printout request signal requesting printout of a corresponding document to the CPU 130, the CPU 130 applies the printout request signal to the printer driver 160 so that the printer driver 160 generates printout data. Further, the setting information decision unit 220 of the printer driver 160 sends the document and the document attribute information which are provided by the application program unit 150 to the setting information storage unit 210 in order for the setting information storage unit 210 to check whether to store the first option information corresponding to the document attribute information. According to a result of the checking, the setting information decision unit 220 determines whether the document has been printed before based on the first option information, and sends a result of the decision to the control unit 230.

If the document has been previously printed, the control unit 230 sends the setting information storage unit 210 a query on whether the first option information is stored, receives the first option information, and generates a print option window to appear as a pop-up window on the display unit 125.

Accordingly, even when a print order is inputted through a selection of a short-cut icon displayed on a menu bar of an application program, the document may be printed again based on the previously stored first option information if the previously stored first option information used for previous printout for the document exists.

However, if a print order is inputted for the document through selection of a short-cut icon, but the first option information is not stored in the setting information storage unit 210, the printer driver 160 converts the document, the document attribute information, and the default values into printout data. That is, the document is printed based on the default values since the document has not been printed, has not option information stored, and has no change to the option information through the user input unit 110.

Meanwhile, if the first setting information is not stored in the setting information storage unit 210 or the first setting information is changed to second setting information by manipulation on the user input unit 110 after displayed on the print setting check window as shown in FIG. 3C, the control unit 230 generates a print option setting window on which the second setting information is displayed as shown in FIG. 3E, and outputs the print option setting window to the display unit 125. In comparison of FIG. 3C and FIG. 3E, the first and second option information is different in the number of copies and print resolution.

If the print option window is displayed as shown in FIG. 3E, the print options are changed to the second option information, and the ‘OK’ button is selected through the user input unit 110. The changes to the option information are sent to the setting information decision unit 220, and the setting information storage unit 210 updates the first option information with the second option information. That is, the setting information storage unit 210 stores the second option information by matching the second option information to the attribute information for a document requested for printout. Further, the printer driver 160 converts the document, the document attribute information, and the second setting information into printout data.

With reference again to FIG. 1, the spooler 170 is illustrated as sending printout data from the printer driver 160 to the port monitor 180 according to a processing speed of the image-forming device 300. In general, the spooler 170 sends printout data by the page unit.

The port monitor 180 monitors ports connected to the image-forming device 300 in an electrical and physical manner, and passes printout data from the spooler 170 to the image-forming device 300 through the connected ports.

The communication interface unit 190 comprises plural ports, and at least one of the plural ports is connected to the image-forming device 300. The plural ports include an LPT port, a network port, a Universal Serial Bus (USB) port, and so on. Such a communication interface unit 190 sends printout data for a certain document to the image-forming device 300 through the communication network 10.

If the print data output device 100 comprises a hard disc drive, the hard disc drive may be installed with the application program unit 150, the printer driver unit 160, and the spooler 170.

The image-forming device 300 performs a job printing printout data sent from the printout data output device 100 on sheets of paper. For example, if the sent printout data contains the first option information, the image-forming device 300 prints the document based on the first option information.

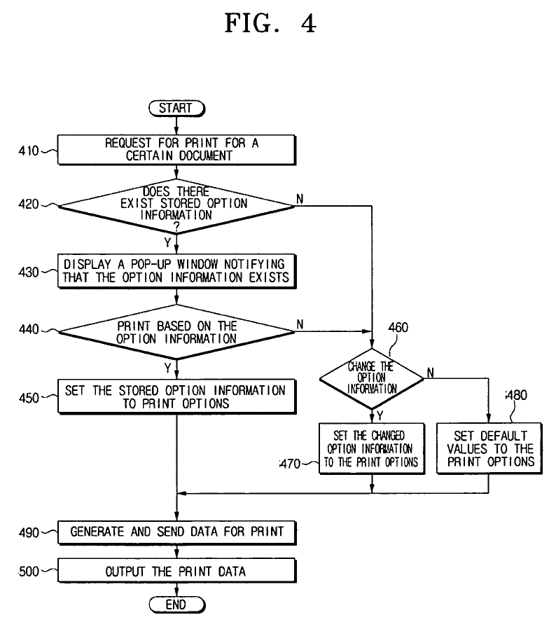

FIG. 4 is a flow chart schematically explaining a method of printing a document using the print option setting method of FIG. 1. As shown in FIG. 4, if a user requests printout of a certain document through the user input unit 110 by pressing the ‘OK’ button on a print window displayed by selection of the Print option of the File menu as shown in FIG. 3A or by selecting the short-cut icon for the print option on the menu bar as shown in FIG. 3D (410), the application program unit 150 sends the document and the document attribute information to the printer driver 160.

The setting information decision unit 220 then decides if the setting information storage unit 210 stores the first option information corresponding to the attribute information about the document (420).

If the first option information exists in the setting information storage unit 210 in operation 420, the setting information decision unit 220 decides that the document has been printed before based on the first option information, and outputs a result of the decision to the control unit 230. Further, the control unit 230 generates and outputs on the display unit 125 a print option check window displayed with the first option information shown in FIG. 3C according to the first option information stored in the setting information storage unit 210 (430).

If a user selects “YES” to the question of whether to print the document according to the first option information through the print option check window, the printer driver 160 sets the first option information to print options for the corresponding document (450), and converts the document, the document attribute information, and the first option information into printout data through a printer driver. The converted printout data is then sent to the image-forming device 300 through the communication interface unit 190 (490).

Meanwhile, if the first option information does not exist in the setting information storage unit 210 in operation 420, the setting information decision unit 220 decides whether the option information has been changed through the user input unit 110 (460). Further, even when “YES” button is not selected in operation 440, the setting information decision unit 220 determines whether the option information has been changed by the user input unit 110 (460).

If the option information is not changed, the printer driver 160 sets the default values to the print options for the document (480), and converts the document, the document attribute information, and the default values to printout data, and sends the printout data to the image-forming device 300 (490).

However, if the option information is changed to the second option information, the printer driver 160 sets the second option information to the print options for the document, converts the document, the document attribute information, and the second option information into printout data, and sends the printout data to the image-forming device 300 (490).

Thus, the image-forming device 300 performs image-processing for printout of the sent printout data and outputs the printout data to sheets of paper, or other recording media (500).

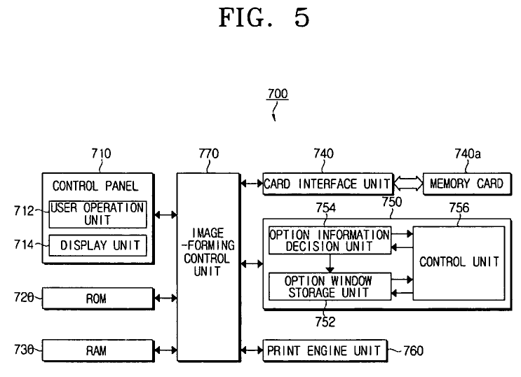

FIG. 5 is a block diagram showing an image-forming device employing a print option setting unit according to another embodiment of the present invention.

The image-forming device 700 shown in FIG. 5 is a device performing print jobs, and description will be made on a photo printer, for example. The photo printer is a printer for printing still images or moving pictures captured by an image-capturing device such as a digital camera or a camcorder. Hereinafter, the still images or moving pictures are referred to as images.

As shown in FIG. 5, the image-forming device 700 comprises a control panel 710, a ROM 720, a RAM 730, a card interface unit 740, a print option setting unit 750, a print engine unit 760, and an image-forming control unit 770.

The control panel 710 comprises a user operation unit 712 and a display unit 714. The user operation unit 712 is provided with plural keys to allow for a selection and a setting of a function supported by the image-forming device 700, a touch panel, and so on, and applies a selected signal to the image-forming control unit 770. The display unit 714 displays the operation status of the image-forming device 700 according to the controls of the image-forming control unit 770, and built with an LCD in general.

The ROM 720 is a memory to store various control programs necessary for carrying out the function of the image-forming device 700, and the RAM 730 is a memory to store various data occurring during the operations of the image-forming device 700.

The card interface unit 740 is provided with at least one mobile memory card 740a. There are several types of memory cards 740a that could be used. These include USB memory, compact flash, smart media, memory stick, Secure Digital, Multimedia Card (MMC), Micro Drive (MD), etc., and/or a combination thereof.

The print option setting unit 750 acting as a print option setting device comprises an option information storage unit 752, an option information decision unit 754, and a control unit 756. The print option setting unit 750 shown in FIG. 5 operates similarly to the printout option setting unit 200 shown in FIG. 2, so a detailed description thereof will be omitted. Here, the print option setting unit 750 is installed as one module in the image-forming device 700.

First, if printout is requested through the user operation unit 712 for a certain image stored in the memory card 740a, the option information decision unit 754 outputs attribute information about the image to the option information storage unit 752. The option information storage unit 752 checks if the third option information for print options corresponding to the inputted attribute information exists, and outputs a result of the check to the option information decision unit 754.

If the third option information exists, the option information decision unit 754 determines that the certain image has been printed before based on the third option information, and outputs a result of the decision to the control unit 756.

The control unit 756 receives the third option information from the option information storage unit 752 based on a result of the decision that the third option information exists. Further, the control unit 756 generates a print option check window on which the third option information is displayed. The generated print option check window is displayed on the display unit 714. A user may change the third option information into the fourth option information by manipulating the user operation unit 712. Here, if the image is printed out based on the changed fourth option information, the third option information is updated to the fourth option information in the option information storage unit 752.

Meanwhile, if the third option information is determined to not exist, the option information decision unit 754 determines that the image has not been printed out, and outputs a result of the decision to the control unit 756.

The control unit 756 prints the image out based on the default values for the print options according to the decision result that the image has not been printed before. However, if a user manipulates the user operation unit 712 to change the default values for the print options into the fourth option information, the image is printed based on the changed fourth option information, and the default values are updated to the fourth option information in the option information storage unit 752.

Thus, if a user intends to print an image, which was printed based on print option information that is different from previous default values, another time, the user may eliminate the hassles of having to perform separate manipulations or re-settings of the print options to the same print options as previously set. This is possible when the previously set print option information is stored by the image attribute information.

The print engine unit 760 prints the image out on paper according to the controls of the image-forming control unit 770.

The image-forming control unit 770 controls the overall operations of the image-forming device 700 according to a control program stored in the ROM 720. In an embodiment of the present invention, if the memory card 740a is mounted into the card interface unit 740, the image-forming control unit 770 controls the interface unit 740 to read out the attribute information of the image stored in the memory card 740a and send the attribute information to the print option setting unit 750. Further, if certain print options are set through the print option setting unit 750, the image-forming control unit 770 controls the print engine unit 760 to print the image read out based on the option information of the set print options.

Meanwhile, as shown in FIGS. 1-5, the option information storage units 210 and 752 automatically delete the option information of the changed print options if a certain time lapses after the default values for print options are changed. If re-printout is requested for a document which has been printed out before and automatically deleted, the default values for print options are displayed. This more efficiently uses the space of the storage medium that the print option information occupies.

Further, the print option setting units 200 and 750 selectively apply the aforementioned aspects of the present invention to documents or images on a file format basis. That is, the aforementioned aspects of the present invention may be used when the file extension of a document or an image stored in a file form is included in pre-set and specific file extensions.

For example, if the pre-set particular file extensions include ‘*.gul, *hwp, *.jpg’ and the file extension of a document requested for print is ‘*.doc’, the setting information, other than default values for the document, is not stored even though the document is printed based on the option information other than the default values. Thus, if the document is requested again for printout, the print option window is displayed on the screen with default values for print options.

As is described above, the print option setting method and device according to aspects of the present invention store the print option information used for a document which has been printed before, enabling a user to print the same document based on the previously used print option information without requiring separate manipulations by the user when the document is printed again later. Further, aspects of the present invention print a document based on previously used print option information without the separate manipulations even when a user requests re-printout of the document by using a short-cut icon for print. Thus, aspects of the present invention eliminates hassles of the separate manipulations or re-inputs of the same print option information by automatically displaying the previously used setting information when a user wants the re-printout of the same document.

Although a few embodiments of the present invention have been shown and described, it would be appreciated by those skilled in the art that changes may be made in this embodiment without departing from the principles and spirit of the invention, the scope of which is defined in the claims and their equivalents.

What is claimed is:

1. A print option setting method for a print option setting device to set print options for a document, comprising:
requesting a printout of the document;
determining whether first setting information as print options that are set when the document was previously printed exists; and
printing the document based on the first setting information if the first setting information exists.

2. The print option setting method as claimed in claim 1, further comprising displaying a print option check window asking whether to print the document based on the first setting information if the first setting information exists.

3. The print option setting method as claimed in claim 2, wherein the print option check window displays the first setting information.

4. The print option setting method as claimed in claim 2, further comprising displaying a print option window when an input button is selected, wherein the print option window comprises an input button to change the first setting information.

5. The print option setting method as claimed in claim 4, wherein, if the first setting information is changed into second setting information through the print option window, the print option window displays the changed second setting information, and the printing prints the document based on the changed second setting information.

6. The print option setting method as claimed in claim 5, further comprising updating the first setting information into the second setting information and storing the second setting information.

7. The print option setting method as claimed in claim 2, further comprising deciding whether the print options are changed into third setting information through a print option window if the first setting information for the document does not exist, wherein,
if the print options are changed to the third setting information, the printing prints the document using the third setting information, and,
if the print option is not changed to the third setting information, the printing prints the document based on default values.

8. The print option setting method as claimed in claim 1, wherein a user input signal is generated when a short-cut icon is selected for a print order input in an application program for editing the document.

9. The print option setting method as claimed in claim 1, wherein the print option setting device is installed in a printer driver and/or an image-forming device to print the document.

10. A print option setting device to set print options for a document via a display unit, comprising:
a setting information storage unit to store first setting information as print options set to the document when the document is printed;
a setting information decision unit to determine whether the first setting information exists in the setting information storage unit if the document is requested for printout; and
a control unit to input the first setting information from the setting information storage unit if the first setting information exists, to generate a print option check window querying whether the document is to be printed based on the first setting information, and to activate the display unit to display the print option check window.

11. The print option setting device as claimed in claim 10, wherein the print option check window displays the first setting information.

12. The print option setting device as claimed in claim 11, wherein the print option check window has an input button to allow for a change of the first setting information, and, if the input button is selected, the control unit displays a print option window on the display unit.

13. The print option setting device as claimed in claim 12, wherein, if the first setting information is changed to second setting information through the print option window, the control unit displays the changed second setting information on the print option window.

14. The print option setting device as claimed in claim 13, wherein, if the printing is performed based on the second setting information, the setting information storage unit updates the first setting information with the second setting information and stores the second setting information.

15. The print option setting device as claimed in claim 10, wherein,
if the first setting information for the document does not exist, the setting information decision unit determines whether the print options are changed to third setting information through a print option window displayed on the display unit,
if the print options are changed to the third setting information, the setting information decision unit sets the print options for the document to the third setting information, and,
if the print options are not changed to the third setting information, the setting information decision unit sets the default values to the print options.

16. A method of setting print options for a document to be printed, comprising:
determining whether previously set first print options exist;
displaying the previously set first options to a user to allow for manipulations thereof by the user to generate second print options; and
printing the document based on the previously set first print options if the user does not perform the manipulations or printing the document based on the second print options if the user performs the manipulations.

17. The method according to claim 16, further comprising saving the second print options and replacing the previously set first print options with the second print options.
